(19) United States
(12) Patent Application Publication
(10) Pub. No.: US 2010/0246203 A1
(43) Pub. Date: Sep. 30, 2010

(54) SYSTEM AND METHOD FOR EXTERIOR LIGHTING OF VEHICLES

(75) Inventors: Jie Chen, Novi, MI (US); Ben Wang, Northville, MI (US); Luc Guy Louis Lacroix, West Bloomfield, MI (US); Amine Taleb-Bendiab, Ann Arbor, MI (US)

Correspondence Address: BROOKS KUSHMAN P.C., 1000 TOWN CENTER, TWENTY-SECOND FLOOR, SOUTHFIELD, MI, 48075, US

(73) Assignee: NORTH AMERICAN LIGHTING, INC., Farmington Hills, MI (US)

(21) Appl. No.: 12/412,709

(22) Filed: Mar. 27, 2009

(51) Int. Cl. B60Q 1/00

(52) U.S. Cl. 362/538

(57) ABSTRACT

A system and method for exterior projection lighting of a vehicle include a generally ellipsoidal faceted reflector disposed on a rear side of a projection lens. First and second focal points of each facet define corresponding reflector focal regions. A semi-conducting light source positioned at an acute angle, such as a single light emitting diode (LED) without a primary optic, emits light toward the reflector from within the first reflector focal region. Reflected light passes through the projection lens to illuminate a desired beam pattern. A curved shade disposed between the projection lens and the light source has at least a portion of a top edge disposed within the second reflector focal region. The shade blocks a portion of reflected light from extending below the optical axis.

### BACKGROUND

1. Technical Field

The present disclosure relates to systems and methods for exterior projection lighting of vehicles.

2. Background Art

Conventional vehicle exterior lighting has relied upon light sources that are relatively inefficient, such as incandescent or halogen lamps, for example. While these light sources are suitable for many applications, they often present challenges with respect to managing the significant amount of heat generated relative to the illumination provided. In addition, vehicle lighting has evolved from a purely functional role to a combination of function and aesthetics that is very often an important design feature that defines the style and character of the vehicle. In addition to being inefficient, the physical packaging constraints associated with various types of conventional light sources may constrain designers in providing unique styling features while still meeting the photometric requirements for a given lamp function.

Advances in material technology have afforded the opportunity to incorporate more efficient light sources into vehicle lighting applications. Originally used only in signal automotive lighting due to relatively limited luminous flux, semi-conductor light-emitting elements, such as light-emitting diodes (LEDs), have more recently been used as light sources in both reflector-type and projector-type as illumination devices in exterior vehicle lamps. Use of these light sources can provide greater flexibility in packaging to provide a wider variety of aesthetically pleasing lighting designs. However, multiple light sources may be required to meet the photometric requirements. This imposes different design constraints than traditional incandescent light sources.

### SUMMARY

A system and method for vehicle exterior lighting include a projection lens having an optical axis and an extended semi-conducting light source transversely disposed on a rear side of a back focal point of the projection lens at an angle relative to the projection lens optical axis and facing a reflector that reflects light from the light source toward the projection lens. A curved shade is disposed between the projection lens and the light source generally below the optical axis of the projection lens.

In one embodiment, a method for forward projection lighting of a vehicle includes directing light from a generally flat emitting surface of a semi-conducting light source disposed near a first focal point of a generally ellipsoidal reflector. The light source, implemented by an LED in one embodiment, is angled such that its axis, which is orthogonal to its emitting surface, forms an acute angle relative to the optical axis. The light source directs light generally rearward toward the generally ellipsoidal reflector. The method includes reflecting light from the generally ellipsoidal reflector toward a second focal point of the reflector and through a projection lens to generate a beam pattern extending generally horizontally in front of the vehicle, wherein the projection lens includes a back focal point positioned generally near the second focal point of the reflector.

Another embodiment of the present disclosure includes a vehicle fog lamp that includes a projection lens having a back focal point and an optical axis passing therethrough. A poly-ellipsoidal reflector having a plurality of juxtaposed ellipsoidal facets is disposed on a back side of the projection lens above a plane containing the optical axis. Each facet of the reflector has a corresponding first and second focal point. The plurality of first focal points defines a first focal region of the faceted reflector and the plurality of second focal points defines a second focal region of the reflector. A semi-conducting light source is disposed on a rear side of the back focal point of the projection lens and faces generally away from the projection lens and toward the reflector. The light source is disposed at an acute angle relative to the optical axis within the first focal region of the plurality of reflector facets. A shade curving away from the projection lens and having an apex with an upper edge of the apex disposed within the second focal region of the reflector is disposed between the projection lens and the light source. The shade blocks a portion of reflected light, thus creating a desired cutline in the beam pattern, and it also conceals the light source supporting structure from exterior view. The shade may also include a generally horizontally disposed reflective surface extending away from the projection lens to further improve light collection efficiency.

The light source may include a plurality of monolithic semi-conducting elements, such as a multi-chip, light emitting diodes (LEDs), juxtaposed in a linear array positioned transverse relative to the optical axis at an angle of between about 10 degrees and about 30 degrees depending on the particular application and implementation. In one embodiment, a fog lamp includes a light source implemented by only a single monolithic rectangular array of light-emitting elements positioned at an angle of about 20 degrees relative to the optical axis.

The present disclosure includes embodiments having various advantages. For example, the systems and methods of the present disclosure provide exterior vehicle lighting with high optical efficiency such that the size/number of light sources needed to achieve a desired photometric performance is reduced, which facilitates a low profile lamp package. Reduced lamp packaging size offers greater flexibility for vehicle designers to provide aesthetically pleasing and unique vehicle lighting solutions, and at the same time meets or exceeds photometric requirements for a given forward lighting function.

The above advantages and other advantages and features will be readily apparent from the following detailed description of the preferred embodiments when taken in connection with the accompanying drawings.

### DETAILED DESCRIPTION OF THE DRAWINGS

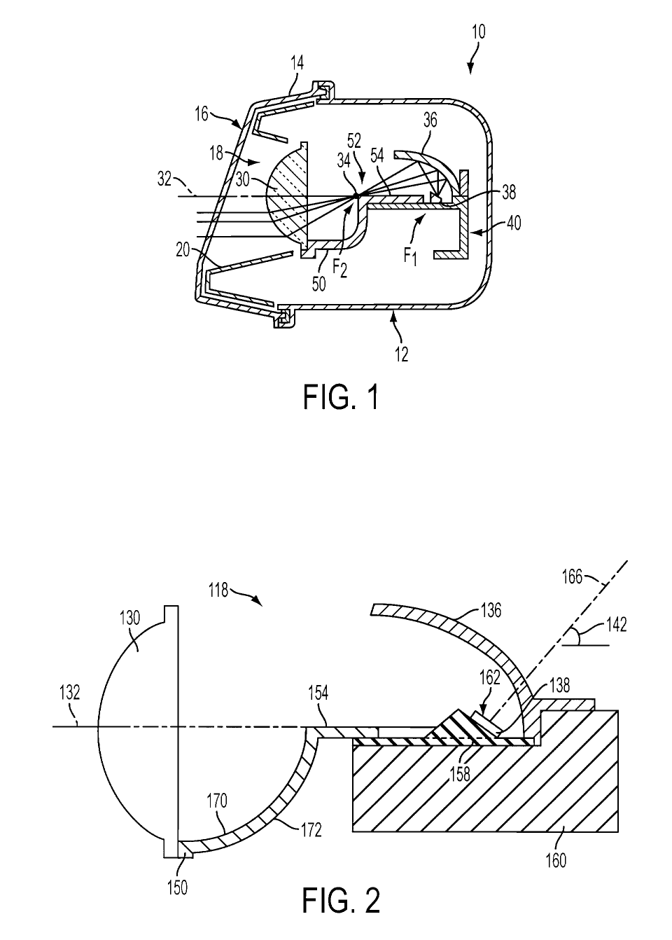

FIG. 1 is a vertical cross-section of a representative vehicle lamp assembly having a vehicle lamp according to one embodiment of the present disclosure;

FIG. 2 is a vertical cross-section illustrating components of a vehicle lamp according to one embodiment of the present disclosure;

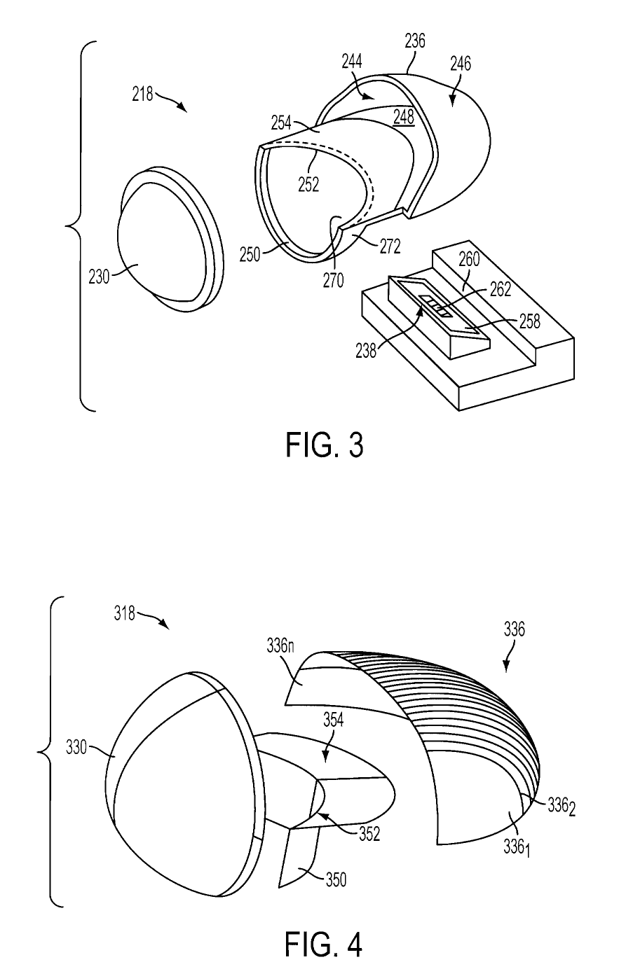

FIG. 3 is a perspective assembly view of components for a vehicle lamp according to one embodiment of the present disclosure;

FIG. 4 is a computer generated model illustrating a vehicle lamp having a projection lens, shade with upper mirrored surface, and poly-ellipsoidal reflector according to one embodiment of the present disclosure;

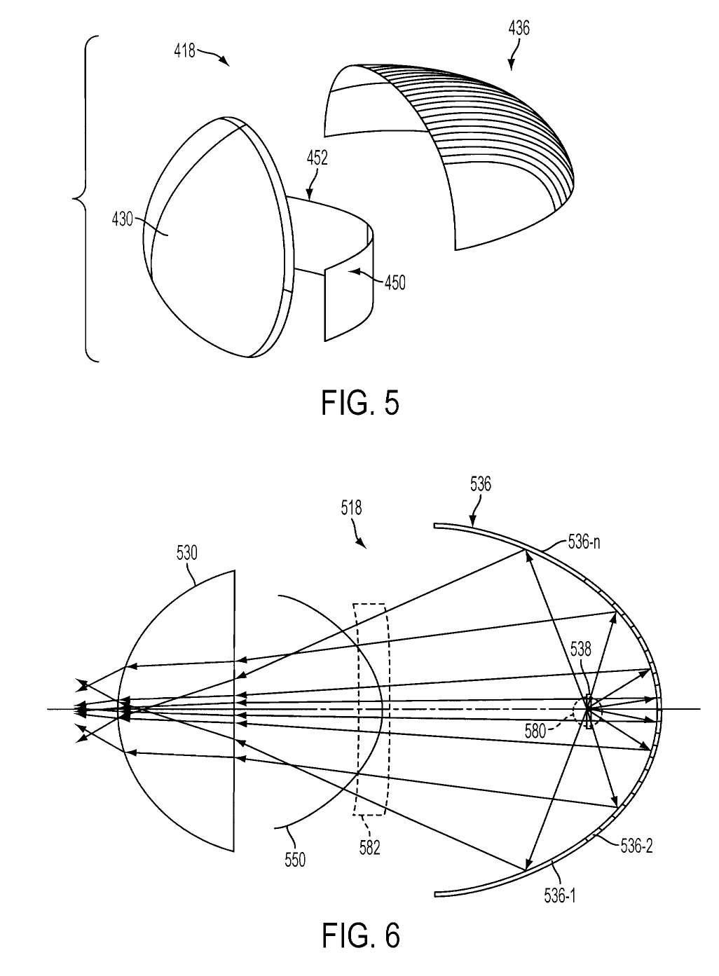

FIG. 5 is a computer generated model illustrating another embodiment of a vehicle lamp having a shade without an upper mirrored surface according to the present disclosure;

FIG. 6 is a plan view illustrating first and second focal regions of a vehicle lamp having a poly-ellipsoidal reflector according to one embodiment of the present disclosure;

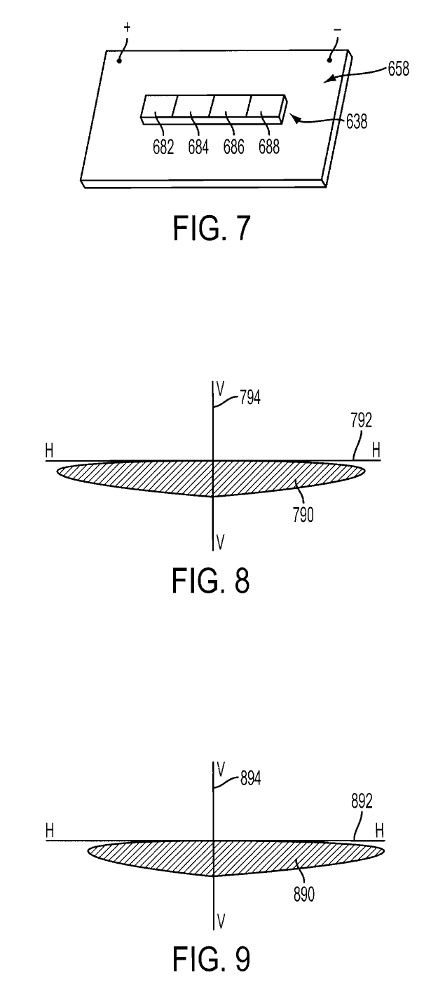

FIG. 7 is a perspective view illustrating a monolithic linear array of juxtaposed semi-conducting elements on a common die for use in a vehicle lamp according to embodiments of the present disclosure;

FIG. 8 illustrates a representative beam pattern for a vehicle lamp implemented as a fog lamp (symmetric beam) according to one embodiment of the present disclosure; and

FIG. 9 illustrates a representative beam pattern for a vehicle lamp implemented as a fog lamp (asymmetric beam) according to one embodiment of the present disclosure.

### DETAILED DESCRIPTION OF EMBODIMENT(S)

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. The representative embodiments used in the illustrations relate generally to exterior projection, also referred to as forward, lighting for a vehicle using a single or small number of semi-conducting light sources, such as one or more LEDs, to provide a desired beam pattern meeting photometric requirements to function as a fog lamp. However, those of ordinary skill in the art may recognize similar applications or implementations with other engine/vehicle technologies.

Referring now to FIG. 1, lamp assembly 10 includes a housing 12 with a cover 14 with at least a portion of a front surface 16 being transparent to visible light. Cover 14 functions to shield interior components of lamp 18 from debris while allowing substantially all light to pass through and illuminate the exterior of a vehicle in a desired beam pattern, such as illustrated in FIGS. 8-9, for example. Cover 14 may also provide aesthetic design features. In the illustrated embodiment, cover 14 does not significantly alter the light rays passing through it and is not considered an optical element of the system. However, the present invention is independent of the particular optical properties of any such housing cover. Housing 12 may include reflective surface 20, also referred to as a bezel, with an opening around the projection lens. The bezel is primarily for aesthetic purposes as it generally does not affect the optical efficiency of lamp 18.

In the embodiment illustrated in FIG. 1, lamp 18 is a projector-type lamp with a projection lens 30 having an optical axis 32 passing therethrough. Projection lens 30 has a back focal length corresponding to the position of a back focal point 34 along optical axis 32. Projection lens 30 may be implemented by various types of lenses including an aspheric lens, or a spherical lens, for example, depending on the particular application. A generally ellipsoidal reflector 36 is disposed on a rear side of projection lens 30 and has first and second reflector focal points or regions, F1 and F2, respectively, as best illustrated in FIG. 6. As also shown in FIG. 1, a light source 38 is disposed on a rear side of back focal point 34 of projection lens 30 facing generally away from projection lens 30 and toward generally ellipsoidal reflector 36. Light source 38 is transversely positioned near the first reflector focal point or region F1 at an acute angle relative to optical axis 32. Light source 38 is mounted in any suitable fashion to a base support structure 40, which may also support generally ellipsoidal reflector 36.

In one embodiment, light source 38 is implemented by at least one semi-conducting element, such as a light emitting diode (LED). Depending on the particular application and implementation, a plurality of light emitting diodes may be used to meet the photometric criteria of lamp 18. However, embodiments of the present invention may use only a single semi-conducting light emitting source, which may be implemented by a plurality of juxtaposed light emitting elements formed on a monolithic substrate or common die as known in the art. The light emitting elements may be implemented by LEDs, which may or may not have domes, protective transparent coatings, or protective lenses as long as their radiation pattern does not substantially deviate from a Lambertian profile and the LED chip effective lit image is not substantially enlarged by the dome, coating, or lens. However, the LEDs may include a generally rectangular parallelepiped output surface (best illustrated in FIG. 7) that does not significantly affect the path of the emitted light so that it generally maintains a Lambertian or semi-Lambertian radiation pattern. The use of a monolithic LEDs or a linear array of LEDs on a common die provides various advantages that may vary by application and may include smaller package size, desired heat dissipation characteristics, reduced complexity of connections, etc.

With continuing reference to FIG. 1, lamp 18 includes a shade 50 disposed between projection lens 30 and light source 38. Shade 50 is positioned so at least a portion of a top edge, indicated generally by reference numeral 52, is near the second focal point or region F2 of reflector 36. Shade 50 blocks a portion of reflected light from reflector 36 while also concealing support structure 40 and associated connectors, electronics, heat sink, and related components from being visible to an observer when lamp 18 is not in use. In the embodiment illustrated in FIG. 1, shade 50 comprises a curved surface extending below optical axis 32 and an upper edge curving away from projection lens 30 with an apex positioned near the second focal point F2 of reflector 36. Shade 50 may optionally include a generally horizontally disposed reflective or mirrored upper surface 54 extending away from projection lens 30 generally parallel to optical axis 32. Reflective or mirrored surface 54 will further improve the optical efficiency of lamp 18 during operation.

As also illustrated in FIG. 1, during operation of lamp 18, a method for projecting a desired illumination beam pattern from a vehicle lamp includes directing light from light source 38 generally rearward toward generally ellipsoidal reflector 36 from a generally flat emitting surface of semi-conducting light source 38 disposed near the first focal point F1 of generally ellipsoidal reflector 36 along optical axis 32 at an acute angle relative to optical axis 32. The emitted light is reflected from generally ellipsoidal reflector 36 toward a second focal point F2 of reflector 36 through projection lens 30 to generate a beam pattern (FIGS. 8-9) extending generally horizontally in front of a vehicle. As previously described, projection lens 30 includes a back focal point 34 positioned generally near the second focal point F2 of reflector 36.

The method may also include blocking a portion of light reflected from reflector 36 using a shade 50 that curves away from projection lens 30 and has an upper edge 52 with at least a portion near the second focal point F2 of reflector 36. Blocking light from reflector 36 may also include blocking light with a curved surface of shade 50 that extends below a horizontal plane containing optical axis 32 and has an upper edge 52 having an apex positioned rearward relative to back focal point 34 of projection lens 30. Various embodiments of the method may include directing light from a light source implemented by a horizontally positioned light emitting diode array, or directing light from a light source implemented by a horizontally positioned diode array having a plurality of monolithic light emitting elements disposed in a linear array on a common die. Depending on the particular desired photometric criteria, the method may include directing light from only a single light emitting diode through each projection lens 30 of a vehicle to provide a desired illumination pattern for vehicle fog lamps.

FIG. 2 is a vertical cross-section of one embodiment of a vehicle projector lamp according to the present disclosure. Vehicle projector lamp 118 includes components similar in structure and function as corresponding components previously described with reference to FIG. 1 with differences as noted. As shown in FIG. 2, lamp 118 includes a projection lens 130 having an optical axis 132 and a shade 150 extending generally below optical axis 132 with a generally horizontal upper reflective surface 154 extending away from lens 130 toward a generally ellipsoidal reflector 136. Shade 150 may include a reflective, or non-reflective, surface 170 facing projection lens 130 and an opposite non-reflective, or reflective, surface 172.

Light source 138 is positioned near a first focal point of reflector 136 and has an axis 166 normal to the generally flat primary light emitting surface 162 of light source 138 disposed at an acute angle 142 relative to optical axis 132. The value of acute angle 132 may vary by application and implementation, but may preferably be in the range of between about ten (10) degrees and about thirty (30) degrees. In one embodiment of a vehicle fog lamp, angle 142 has a value of about twenty (20) degrees. In another embodiment of a vehicle fog lamp, angle 142 has a value of about twelve (12) degrees. Values may be determined by computer simulation and may vary depending on the desired photometric criteria and the design of the ellipsoidal reflector 136.

As also shown in FIG. 2, light source 138 is a semi-conducting light emitting element. The light emitting element may be implemented by a light emitting diode covered by a visibly transparent and non-optical rectangular parallelepiped output coupler with a generally flat primary light emitting surface 162 positioned as shown. Light source 138 may be in contact with a heat sink 158, which in turn contacts thermally conductive base 160 to provide heat dissipation. For efficient thermal transfer, thermally conductive materials can be used between 138 and 158, and likewise between 158 and 160.

A perspective assembly drawing illustrating various components of a vehicle projection lamp according to one embodiment of the present disclosure is illustrated in FIG. 3. The components of lamp 218 are similar in structure and function to those previously illustrated and described with respect to FIGS. 1-2. In particular, projector-type lamp 218 includes a projection lens 230, a shade 250, a generally ellipsoidal reflector 236, and a light source 238.

Shade 250 may include reflective or non-reflective surfaces 270 and 272. Upper edge 252 of shade 250 curves away from projection lens 230 and has an apex disposed near a second focal point of reflector 236. Shade 250 also extends generally below an optical axis of lens 230. Upper surface 254, generally reflective, extends from upper edge 252 away from lens 230 generally horizontally in a plane parallel to, or coincident with, the optical axis of lens 230.

Generally ellipsoidal reflector 236 may include a reflective surface 244 and a non-reflective surface 246. An opening 248 accommodates light source 238 such that light source 238 is positioned near the first focal point of reflector 236 when lamp 218 is assembled. In one embodiment, light source 238 is centered about the first focal point of reflector 236 and the apex of upper edge 252 along the optical axis of lens 230 is positioned near the second focal point of reflector 236.

Light source 238, which is mounted on a substrate 258, includes a visibly transparent and generally rectangular parallelepiped output coupler having a primary light emitting surface 262 disposed at an acute angle by means of supporting structure 260.

FIGS. 4 and 5 are computer models illustrating alternative embodiments of a projector-type vehicle lamp according to the present invention. In the embodiment of FIG. 4, lamp 318 includes a projection lens 330, a shade 350 and a reflector 336. Shade 350 includes an upper edge 352 and upper surface 354 as previously described with respect to the embodiments of FIGS. 1-3. Generally ellipsoidal reflector 336 is implemented by a poly-ellipsoidal surface having a plurality of juxtaposed ellipsoidal facets 336-1, 336-2 . . . 336-n, each having corresponding first and second focal points defining associated first and second focal regions 580, 582 (FIG. 6). A computer simulation may be used as an aid in varying the optical parameters of one or more facets to produce a desired illumination beam pattern and to estimate corresponding photometric values to achieve design objectives. Similarly, the embodiment of lamp 418 shown in FIG. 5 includes a projection lens 430, shade 450 and poly-ellipsoidal reflector 436. Shade 450 includes an upper edge 452, however, unlike shade 350 which includes an upper horizontal surface 354, shade 450 does not.

In embodiments having a poly-ellipsoidal reflector, the curvature of shade 350 and 450, in FIGS. 4 and 5, respectively, has been optimized to follow the profile of the second focal region. The curvature optimization was created using a well defined shape, such as parabolic, elliptical, circular, or any conic curve, or even a combination of multi-conic curve sections and flat sections. This also resulted in enhanced optical system efficiency.

A computer model representing a lamp having an aspheric projection lens 330, 430 with a diameter of about 45 mm, and a reflector 336, 436 of about 64 mm wide, 23 mm high and about 37 mm deep was used to determine estimated system efficiency. Each reflector 336, 436 was formed by (24) juxtaposed facets or segments of varying size. A transversely positioned LED light source comprised of only a single LED was positioned facing the reflector 336, 436 at an angle of about twenty (20) degrees relative to the optical axis. Computer simulation determined a system optical efficiency of about 52% using a reflective or mirrored upper surface 354 as shown in FIG. 4. A system optical efficiency of about 48% was determined using shade 450 without a horizontally extending upper surface.

Referring now to FIG. 6, a horizontal cross-section of a representative projector-type lamp for a vehicle according to one embodiment of the present invention is shown. Lamp 518 includes a projection lens 530, shade 550, and multi-faceted poly-ellipsoidal reflector 536. Each facet 536-1, 536-2 . . . 536-n will have an associated first and second focal point. The plurality of first focal points corresponding to the plurality of facets define a first focal region 580, while the plurality of second focal points corresponding to the plurality of facets defines a second focal region 582. The size and shape of focal regions 580, 582 will depend on the particular application and the desired illumination beam pattern and system efficiency. Those of ordinary skill in the art will recognize that first and second focal regions 580, 582 may not be circular and that one or more of the first focal points may be substantially coincident with one another. Likewise, one or more of the second focal points may be substantially coincident with one another. Light source 538 is preferably positioned within first focal region 580, while apex of shade 550 is preferably positioned within focal region 582 as previously described.

FIG. 7 is a perspective view of one embodiment of a light source 638 comprising a plurality of semi-conducting light emitting elements 682, 684, 686, 688 mounted on a monolithic substrate 658. Light emitting elements 682, 684, 686, 688 are juxtaposed in a linear array having a rectangular output. When implemented as a linear array of elements as shown, light source 638 comprises an extended light source that is preferably transversely positioned relative to an optical axis of a projection lens, and mounted at an acute angle by means of a supporting structure as previously described and illustrated with respect to FIGS. 1-6.

FIG. 8 illustrates a representative illumination beam pattern for a projector-type lamp according to embodiments of the present invention for a typical vehicle forward lighting application, and more specifically a vehicle fog lamp with a symmetric beam pattern. As illustrated in FIG. 8, illumination beam pattern 790 is generally contained below a horizontal line 792 and generally symmetrically disposed about vertical axis 794. Illumination beam pattern 790 may be adjusted for particular applications using various system design parameters as described herein including, positioning of a shade, projection lens, light source, shape of one or more segments of a poly-ellipsoidal reflector, and the like. For example, the system design parameters may be adjusted to provide an asymmetric beam pattern as shown in FIG. 9. Computer modeling and/or simulation may be used to meet various functional photometric criteria, packaging constraints, and design aesthetics according to the teachings of the present invention.

FIG. 9 illustrates a representative illumination beam pattern for a projector-type lamp according to embodiments of the present invention for a typical vehicle forward lighting application, and more specifically a vehicle fog lamp with an asymmetric beam pattern. As illustrated in FIG. 9, illumination beam pattern 890 is generally contained below a horizontal line 892 and generally asymmetrically disposed about vertical axis 894. For example, such a design can be utilized in the creation of both a fog lamp and cornering lamp functions with the projector unit.

As such, the systems and methods of the present disclosure provide exterior vehicle lighting with high optical efficiency such that the size/number of light sources needed to achieve a desired photometric performance is generally reduced, which facilitates a low profile lamp package. Reduced lamp packaging size offers greater flexibility for vehicle designers to provide aesthetically pleasing and unique vehicle lighting solutions that meet or exceed the photometric requirements for a given lamp function.

While the best mode has been described in detail, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments discussed herein that are described as less desirable than other embodiments or prior art implementations with respect to one or more characteristics are not outside the scope of the disclosure and may be desirable for particular applications.

What is claimed:

1. A vehicular projection lamp comprising:
a projection lens having a back focal point and an optical axis passing therethrough;
a generally ellipsoidal reflector disposed on a rear side of the projection lens and having first and second reflector focal points;
a light source disposed on a rear side of the back focal point of the projection lens facing generally away from the projection lens and toward the reflector, the light source being disposed near the first reflector focal point and having an axis normal to a primary light emitting surface disposed at an acute angle relative to the projection lens optical axis; and
a shade disposed between the projection lens and the light source and having at least a portion of a top edge disposed near the second focal point of the ellipsoidal reflector, the shade blocking a portion of reflected light from the reflector.

2. The lamp of claim 1 wherein the light source comprises a bare semi-conducting element having a generally rectangular parallelepiped output surface.

3. The lamp of claim 2 wherein the light source comprises a monolithic light-emitting diode.

4. The lamp of claim 1 wherein the light source comprises a linear array of semi-conducting light emitting elements formed on a single die, the linear array disposed transversely relative to the optical axis.

5. The lamp of claim 1 wherein the light source comprises only one light emitting diode having a Lambertian or semi-Lambertian radiation pattern.

6. The lamp of claim 1 wherein the light source is disposed with an orthogonal axis disposed at an angle of less than about 40 degrees relative to the optical axis.

7. The lamp of claim 1 wherein the light source is disposed with an orthogonal axis disposed at an angle of between about 10 and 30 degrees relative to the optical axis.

8. The lamp of claim 1 wherein the shade comprises a curved surface extending below the optical axis and having an upper edge with an apex disposed near the second focal point of the ellipsoidal reflector.

9. The lamp of claim 8 wherein the shade further comprises a generally horizontally disposed reflective upper surface extending away from the projection lens generally parallel to the optical axis.

10. The lamp of claim 1 wherein the lamp generates a beam pattern generally extending below a horizontal line and generally symmetrical about a vertical axis during operation.

11. The lamp of claim 1 wherein the generally ellipsoidal reflector comprises a poly-ellipsoidal reflector having a plurality of juxtaposed ellipsoidal facets disposed above a horizontal plane containing the optical axis, the plurality of facets having corresponding second focal points defining a second focal region.

12. The lamp of claim 11 wherein the lamp generates a beam pattern generally extending below a horizontal line and generally symmetrical about a vertical axis during operation.

13. The lamp of claim 11 wherein the lamp generates a beam pattern generally extending below a horizontal line and generally asymmetrical about a vertical axis during operation.

14. The lamp of claim 11 wherein the shade curvature is defined using a conic curve that would best fit the second focal region profile of the plurality of poly-ellipsoidal reflector segments.

15. The lamp of claim 11 wherein the shade curvature is defined using a combination of multi-conic curve sections and flat sections that would best fit the second focal region profile of the plurality of poly-ellipsoidal reflector segments.

16. The lamp of claim 1 wherein the projection lens comprises an aspheric lens.

17. The lamp of claim 1 wherein the lamp comprises a vehicle fog lamp.

18. A method for forward projection lighting of a vehicle, the method comprising:
directing light from a generally flat emitting surface of a semi-conducting light source disposed near a first focal point of a generally ellipsoidal reflector along an optical axis at an acute angle relative to the optical axis generally rearward toward the generally ellipsoidal reflector;
reflecting light from the generally ellipsoidal reflector toward a second focal point of the reflector and through a projection lens to generate a beam pattern extending generally horizontally in front of the vehicle, wherein the projection lens includes a back focal point positioned generally near the second focal point of the reflector.

19. The method of claim 18 further comprising blocking a portion of light reflected from the reflector using a shade that curves away from the projection lens and has an upper edge near the second focal point of the reflector.

20. The method of claim 18 wherein blocking light comprises blocking light with a curved surface extending below the horizontal plane containing the optical axis and having an upper edge with an apex positioned near the back focal point of the projection lens.

21. The method of claim 18 wherein directing light comprises directing light from a horizontally positioned light emitting diode array.

22. The method of claim 18 wherein directing light comprises directing light from a horizontally positioned diode array having a plurality of monolithic light emitting elements disposed in a linear array.

23. The method of claim 18 wherein directing light comprises directing light from only a single light emitting diode.

24. A vehicle fog lamp comprising:
an aspheric projection lens having a back focal point and an optical axis passing therethrough;
a reflector having a plurality of ellipsoidal facets, the reflector disposed on a back side of the projection lens above a plane containing the optical axis, each facet having corresponding first and second focal points, the plurality of first focal points contained within a first focal region of the reflector and the plurality of second focal points contained within a second focal region of the reflector;
a semi-conducting light source, the light source disposed on a reflector side of the back focal point of the projection lens and facing generally away from the projection lens and toward the reflector, the light source being disposed at an acute angle relative to the optical axis within the first focal region of the plurality of reflector facets; and
a shade curving away from the projection lens and having an apex with an upper edge of the apex disposed within the second focal region of the reflector, the shade disposed between the projection lens and the light source and blocking a portion of light reflected from the reflector to create a beam pattern cutline.

25. The fog lamp of claim 24 wherein the shade comprises a generally horizontally disposed mirrored upper surface extending away from the projection lens and toward the reflector.

26. The fog lamp of claim 24 wherein the semi-conducting light source comprises only one monolithic light emitting diode transversely oriented relative to the optical axis at an angle of about 20 degrees.

27. The fog lamp of claim 26 wherein the only one monolithic light emitting diode comprises a plurality of light emitting elements juxtaposed in a linear array on a common die.
